(19) United States
(12) Patent Application Publication
(10) Pub. No.: US 2015/0126226 A1
(43) Pub. Date: May 7, 2015

(54) WEARABLE ARTICLES IDENTIFICATION

(71) Applicant: Donde Fashion Inc, Palo Alto, CA (US)

(72) Inventors: Dan Zeharia Milikovsky, Binyamina (IL); Liat Zakay, Givataim (IL)

(21) Appl. No.: 14/406,218

(22) PCT Filed: Jun. 5, 2013
(86) PCT No.: PCT/IL13/50484

§ 371 Date: Dec. 7, 2014

Related U.S. Application Data
(60) Provisional application No. 61/656,018, filed on Jun. 6, 2012.

(51) Int. Cl. H04W 4/02

(52) U.S. Cl. CPC H04W 4/02
USPC 455/456.3

(57) ABSTRACT

A method of identifying a wearable article that comprises forwarding a current location of a mobile client terminal of a user to a central unit via a communication network, receiving from the user at least one wearable article property of a target wearable article worn by another user, sending the at least one wearable article property to the central unit via the communication network, receiving a message comprising wearable article information of the target wearable article in response to the at least one wearable article property, and presenting at least one of the wearable article information and data acquired based on the wearable article information to the user using the mobile client terminal.

### BACKGROUND

The present invention, in some embodiments thereof, relates to location based article identification and, more specifically, but not exclusively, to using mobile client terminals for location based article identification.

Location-based services are computerized services which use location and time data as control features. As such location-based services have a number of uses in social networking, for example as a service accessible with mobile devices through the mobile network and uses information on the geographical position of the mobile device. This has become more and more important with the expansion of the Smartphone and tablets.

In a location-based service, a location module or service is used to identify a location of a nearby person or object, for example discovering the nearest banking cash machine or the whereabouts of a friend or employee. Location-based services are also used in mobile commerce and advertising, for example in the form of coupons or advertising directed at customers based on their current location.

Now reference is made to an issue in another from another discipline, fashion. Fashion styles and fashion items that are part of a style, can be hard to discern.

Specifically, it can be hard to identify the source of a particular fashion item when it is not physically available for inspection, for example when it is watched from afar and/or when no noticeable trademark is printed or otherwise founded thereon.

### SUMMARY

According to some embodiments of the present invention there is provided a method of identifying a wearable article. The method comprises managing a plurality of user profiles each indicative of at least one descriptive property of each of a plurality of wearable articles associated with one of a plurality of users, monitoring a location of a plurality of mobile client terminals each associated with another of the plurality of users, receiving from a first of the plurality of mobile client terminals at least one wearable article property of a proximate wearable article, selecting a group of the plurality of user profiles according to a distance between a current location of the first mobile client terminal and a current location of at least one second mobile device from the plurality of mobile client terminals, identifying which member of the group has a matching wearable article with at least one descriptive property which matches to the at least one wearable article property, extracting wearable article information of the matching wearable article, and forwarding the wearable article information to the first mobile client terminal.

Optionally, the managing comprises associating each one of the plurality of wearable articles with respective wearable article information.

Optionally, the managing comprises associating between a user of the plurality of users and a new wearable article in response to a transaction made by the user to purchase the new wearable article.

Optionally, the receiving comprises receiving an estimation of at least one of a distance and a direction of the proximate wearable article, the selecting is performed according to the at least one of the distance and the direction.

Optionally, the wearable article information comprises a member of a group consisting of a unique identifier (ID), an origin retailer, a name, a manufacturer, a current price, a paid price, and a stock availability.

Optionally, the wearable article information comprises a virtual authenticity certificate which indicates the authenticity of the matching wearable article.

Optionally, the wearable article is a clothing item worn by another of the plurality of users.

Optionally, the at least one descriptive property comprises a member of a group consisting of a color, a collar type, a type, a gender designation, a fabric and a size.

Optionally, the identifying comprises: identifying a plurality of members of the group each having a matching wearable article with the at least one descriptive property, extracting at a plurality of distinguishing descriptive properties from the plurality of members, sending the plurality of distinguishing descriptive properties to the mobile client terminal, and identifying which of the plurality of members the matching wearable article according to a match with a group of the plurality of distinguishing descriptive properties which is selected by the user.

More optionally, the method further comprises receiving from a each of a first and a second of the plurality of users data indicative of which of respective the plurality of wearable articles they wear to an event held in a certain place and time, identifying a match between wearable articles indicated by the first and second users for the event, and alerting at least one of the first and second users about the match.

According to some embodiments of the present invention there is provided a method of identifying a wearable article. The method comprises forwarding a current location of a mobile client terminal of a user to a central unit via a communication network, receiving from the user at least one wearable article property of a target wearable article worn by another user, sending the at least one wearable article property to the central unit via the communication network, receiving a message comprising wearable article information of the target wearable article in response to the at least one wearable article property, and presenting at least one of the wearable article information and data acquired based on the wearable article information to the user using the mobile client terminal.

Optionally, the receiving comprises capturing an image of the target wearable article according to a user indication and automatically extracting the at least one wearable article property by an image analysis of the image.

Optionally, the method further comprises receiving a rank given for the target wearable article from the user and updating accordingly at least one of the another user and the attractiveness of the another user with the target wearable.

Optionally, the method further comprises crediting an account of another user according to the presenting.

Optionally, the method further comprises uploading a note with the wearable article information to at least one of a social media page and wish list.

Optionally, the method further comprises directing a browser hosted on the mobile client terminal to a webpage of a retailer selling the wearable article target wearable article.

Optionally, the method further comprises operating a navigation module installed in the mobile client terminal to a store associated with the wearable article target wearable article.

Optionally, the method further comprises operating a call module installed in the mobile client terminal to call a retailer associated with the wearable article target wearable article.

According to some embodiments of the present invention there is provided a system of identifying a wearable article. The system a database which stores a plurality of user profiles each indicative of at least one descriptive property of each of a plurality of wearable articles associated with one of a plurality of users, a plurality of client modules installed in a plurality of mobile client terminals each the client module monitors a current location of a respective the mobile client terminal, renders a user interface allowing a user to indicate at least one wearable article property of a proximate wearable article, and sends a query comprising the at least one wearable article property over a network, and a central unit which receives the query and selects according to data from the database a matching wearable article having the at least one wearable article property. The central unit forwards wearable article information of the matching wearable article to a first of the plurality of mobile client terminals which sends the query and the first mobile client terminal presents the indicative data to the user.

Optionally, the plurality of client modules are used for capturing a plurality of images of a plurality of barcodes each indicative of the wearable article information of another of the plurality of wearable articles and to update the plurality of user profiles accordingly.

According to some embodiments of the present invention, a system of identifying a wearable article. The system comprises a plurality of client modules installed in a plurality of mobile client terminals and allowing each of a plurality of users to send a plurality of queries for wearable article information about a plurality of wearable articles worn by another of the plurality of users which is located in proximity thereto and a central unit which responds to the plurality of queries with respective the wearable article information, the central unit having a logging module which logs the plurality of queries and advertisement module which identify a preference of a first of the plurality of users according to an analysis of a group of the plurality of queries which includes at least one query sent by a respective the mobile client terminal.

According to some embodiments of the present invention, a system of identifying a wearable article. The system comprises a plurality of client modules installed in a plurality of mobile client terminals and allowing each of a plurality of users to send a plurality of queries for wearable article information about a plurality of wearable articles worn by another of the plurality of users which is located in proximity thereto and a central unit which responds to the plurality of queries with a respective the wearable article information indicative of a presence or absence of a virtual authenticity certificate indicative of the authenticity of a respective the wearable article. The central unit forwards the wearable article information to a first of the plurality of mobile client terminals for presentation to the user.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a system that provides users of mobile client terminals with wearable article information pertaining to wearable articles worn by other users, according to some embodiments of the present invention; and

FIG. 2 is a flowchart of a process of identifying a wearable article, according to some embodiments of the present invention.

### DETAILED DESCRIPTION

The present invention, in some embodiments thereof, relates to location based article identification and, more specifically, but not exclusively, to using mobile client terminals for location based article identification.

According to some embodiments of the present invention, there are provided methods and systems which allow users to receive, optionally in real time, wearable article information (e.g. retailer, model number, current availability) of a wearable article that is currently worn by another user located in proximity thereto, for example in a viewing distance. For example, in some embodiments, a user may use the system to receive information indicative of a retailer from which he may purchase a shirt currently worn by another user. The systems and methods optionally involve managing user profiles, such as virtual closets, which document wearable articles owned by each user. Each document wearable article is associated with wearable article information and properties (e.g. color, type, and size). The systems and methods further involve monitoring the locations of users by monitoring the location of their mobile client terminals in real time. The systems and methods enable users to send a query with one or more properties of a target wearable article he notices and to receive in response the respective wearable article information or related data without having to talk with the wearing user. The respective wearable article information is optionally extracted from a user profile of a user identified as located in proximity thereto.

Optionally, the querying user may rank the target wearable article. This will allow the wearing user to estimate the attractiveness of the target wearable article for future uses and advertisers and/or retailers to estimate the preferences of the querying user and to provide him with personalized ads. Optionally, the querying user may be directed to purchase the target wearable article. Optionally, the querying user may watch other target wearable articles of the wearing user and/or follow his future purchases.

According to some embodiments of the present invention, there are provided methods and systems of providing an additional layer of protection against counterfeits. The methods and systems allow users to receive data indicative of a presence or absence of a virtual authenticity certificate for a target wearable article worn by a proximate wearing user without physically probing the target wearable article and/or talking with the wearing user. This methods and systems may deter some users from wearing counterfeits as other users may notice that the articles they wear do not have virtual authenticity certificates.

According to some embodiments of the present invention, there are provided methods and systems of reducing the chances to appear to an event with wearable articles which are identical to the wearable articles of others. In such an embodiment, a database of which articles are to be worn or currently worn by users is managed. When a match between wearable articles is found, a notice is sent to the respective user. Optionally, the system includes a reservation module, allowing users to declare in advance the wearable articles they chose for the event, letting other people know that they should choose other wearable articles and/or notify users when other users chose the same wearable articles.

According to some embodiments of the present invention, there are provided methods of identifying a wearable article. Such a method comprises forwarding a query message to at least one proximate mobile client terminal located in proximity to a querying mobile client terminal of a user via a wireless communication channel, the query message includes at least one wearable article property of a target wearable article worn by another user, receiving a response message comprising wearable article information of the target wearable article in response to the query message directly from the at least one proximate mobile client terminal, and presenting at least one of the wearable article information and data acquired based on the wearable article information to the user using the mobile client terminal.

According to some embodiments of the present invention, there are provided methods of inferring information about physical appearance of a user. Such a method comprises identifying at least one proximate mobile client terminal near a current location of a querying mobile client terminal of a user, inputting by the user at least one physical appearance property of another user, sending a query specifying the at least one physical appearance property a wireless communication channel, receiving a response message comprising physical appearance information related to the physical appearance property in response to the query, and presenting at least one of the physical appearance information and data acquired based on the physical appearance information to the user using the querying mobile client terminal.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

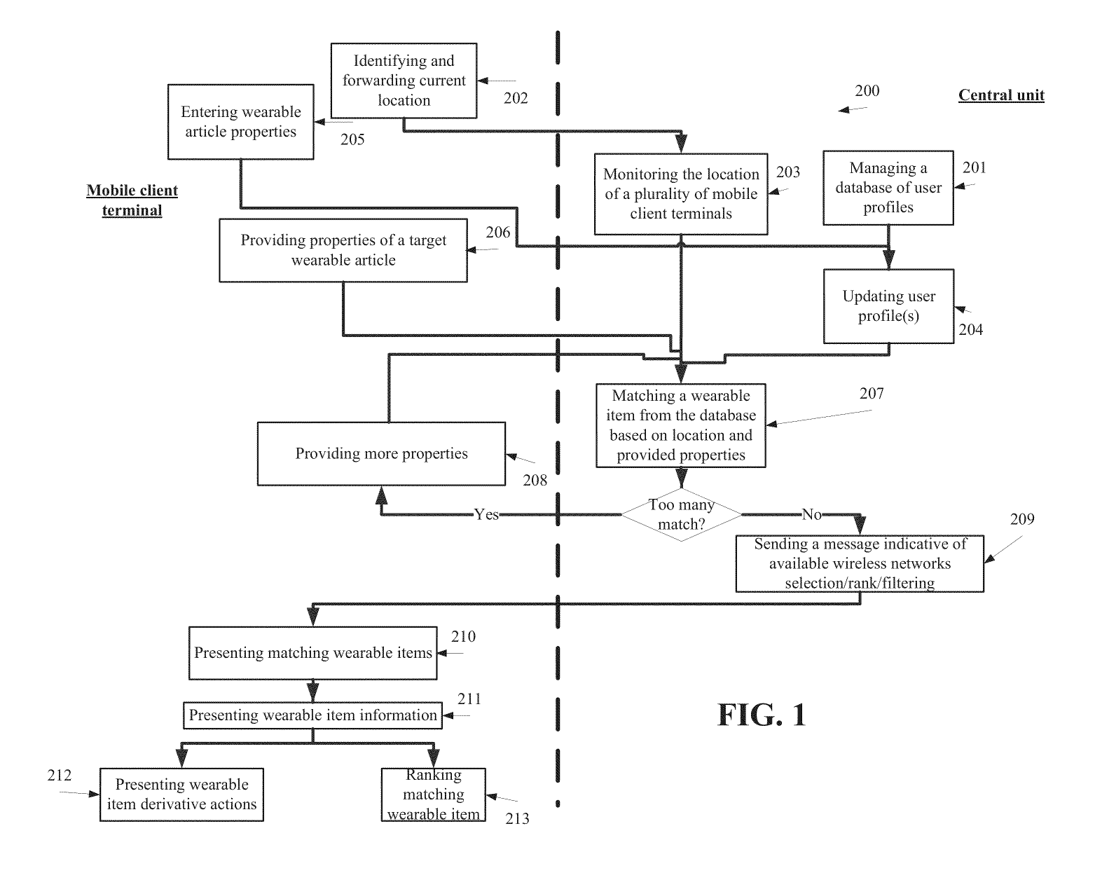

Reference is now made to FIG. 1, which is a schematic illustration of a system 100 that provides users of mobile client terminals 101 with wearable article information pertaining to wearable articles, such as clothing items and accessories, worn by other users, according to some embodiments of the present invention. As used herein, a mobile client terminal means a cellular phone, a Smartphone, a tablet, a laptop, a visual augmented reality device, such as smart glasses, and/or the like. The users may be subscribers of the system 100 for which a user profile (e.g. any set of records which is associated therewith) and/or non subscribers which are tracked by the system 100.

The system 100 allows users to receive wearable article information, such as a unique identifier (ID), origin retailer (i.e. physical store and an online store), a name, a manufacturer, a current price, a paid price, a stock availability, and/or the like of a wearable article that is worn by another user located in proximity thereto, for example in a predefined distance.

The system 100 includes a central unit 102, which may be implemented by one or more servers which are connected to a network, such as the Internet. The central unit 102 optionally manages a database 115 which hosts a plurality of user profiles. Each user profile documents one or more identifiers of each of a plurality of wearable articles of a user. For example, a user profile may include a plurality of wearable article records where each record includes one or more identifier fields (e.g. color, collar type, type, gender designation, fabric and size) and optionally wearable article information. The central unit 102 optionally includes an update module 109 that updates user profiles according to user inputs, for example via a website, webpage, and/or a user interface (UI) that is optionally managed by a module hosted on the mobile client terminals 101. The update module 109 may update user profiles according to inputs from a retailer service and/or software. For example, when a user purchases a certain wearable article, his user profile is updated with a respective wearable article record or a reference thereto (i.e. a link). The updating may be performed depending on a user approval. The updating may be from a related database, for example a customer relationship management (CRM) system, purchase software, a credit or debit card service provider and/or the like.

The central unit 102 further includes a network interface 111, and a location monitoring module 113, and a matching module 112. The central unit may be implemented as a virtual machine running for example in a server of a cloud hosting service. Records may be stored in a cloud storage service.

The central unit 102 communicates via the network interface 111 with a plurality of client terminal modules 103 installed in the mobile client terminals 101, for example applications, such as App Store™ and/or Android Market™ applications, add-ons, and/or software extensions, for brevity may be referred to herein as identification applications.

In use, for example as described below, the client terminal module 103 optionally allows a user to input a query related to a proximate wearable article worn by a user in a viewing distance, by providing one or more wearable article identifiers, such as wearable article type, color, collar type, estimated size, gender designation, fabric, and/or printed pattern description. The input may be performed by typing, selecting identifiers from a list, selecting an exemplary icon and/or by taking a picture of the wearable article (e.g. using the camera of the mobile client terminal, which may be a Smartphone or a visual augment device). Additionally or alternatively, the user may provide one or more identifiers of a respective wearing entity, for example, estimated height range, gender, estimated age, and/or the like. In such an embodiment, the user profile is updated with user physical characteristics. Then, the user client terminal module 103 interacts with the central unit 102, for example transmits current location data from the client terminal module 103 and the one or more identifiers and receives in response related wearable article information, such as identifier(s), origin, and/or purchase information. The user client terminal module 103 may than present the related wearable article information and/or data acquired using the related wearable article information. For brevity, the term wearable article information includes external appearance information, for example identifier(s), service provider, and/or purchase information of a haircut, a manicure treatment, a pedicure treatment, a plastic surgery treatment, a makeup treatment, a makeup product, a cosmetics treatment, a cosmetic product, and/or any other treatment that the outcomes thereof are visible to a user who watches another user.

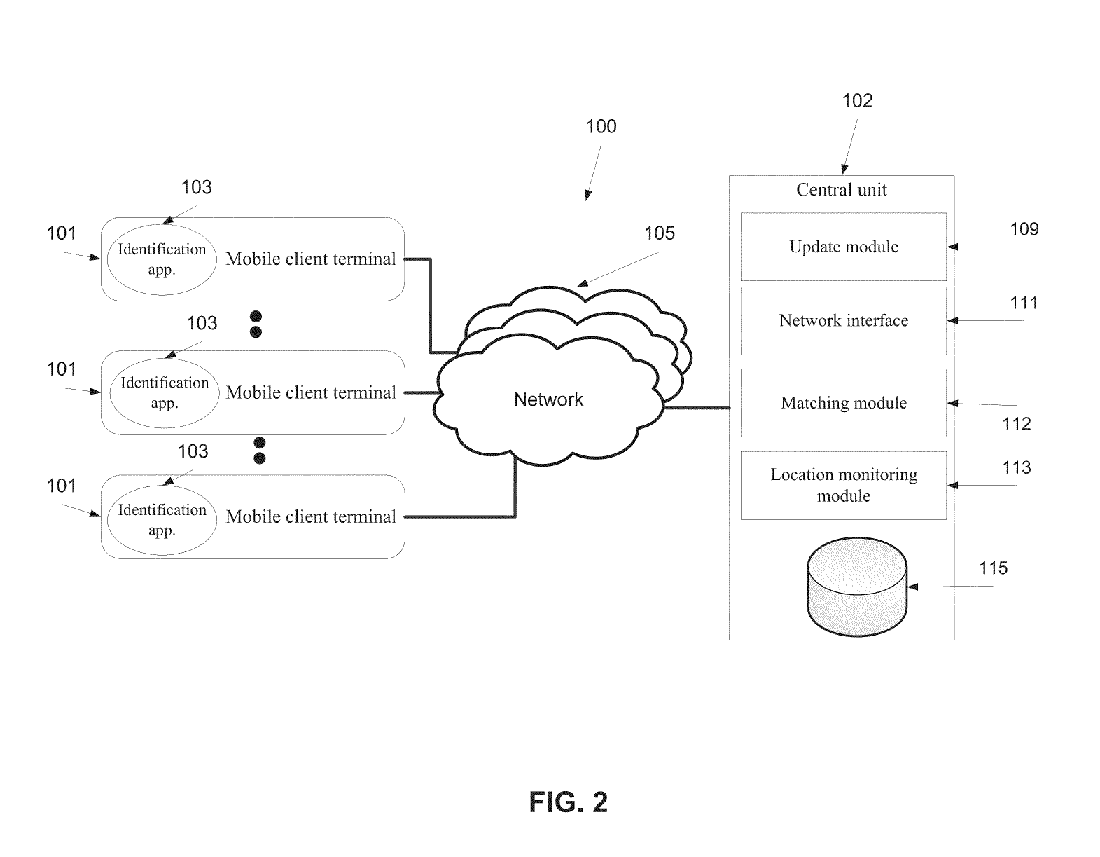

For example, reference is now also made to FIG. 2, which is a flowchart 200 of a process of identifying a wearable article, according to some embodiments of the present invention. The depicted process involves communication between an exemplary user client terminal module, such as 103, and the central unit 102.

As shown at 201, the central unit 102 manages a database of user profiles, for example set as described above. As shown at 204, the database may be updated according to inputs received from a UI of the user client terminal module 103, as shown at 205, and/or from third party services and/or databases, for example as described above. For example, when a user subscribes to the system, his newly created user profile is automatically updated with data about his purchases from databases of one or more retailers and/or the like. Additionally or alternatively, information such as availability, retailers, prices and/or the like may be updated according third party services and/or databases.

During an operation mode, as shown at 202, the user client terminal module 103 monitors the location of the respective user, for example according to the location of the of mobile client terminal 101 as indicated by an integral module, such as a global positioning system (GPS) module and/or location service, such as a cellular location service. The location data is optionally sent periodically and/or upon request to the central unit, for example to the location monitoring module 113. The location monitoring module 113 monitors the location of a plurality of mobile client terminals simultaneously, as shown at 203.

Now, as shown at 206, the user of the user client terminal hosting the user client terminal module may provide one or more properties of a wearable article which is located, for example worn, in proximity thereto. In such an embodiment, a user who sees a person wearing an attractive target wearable article, such as a shirt, pants, shoes, eyeglasses, sunglasses, a jewelry item, an accessory and/or the like may provide one or more properties of the target wearable article via a designated graphical user interface (GUI) that is presented thereto, for example on the display of the user client terminal. The properties may be provided by typing, image selection, image capturing and/or the like. Additionally or alternatively, the user may indicate in which direction and/or distance a target wearable article is located, for example using a pointer user interface and/or a distance scale user interface that is displayed on a touch screen of the mobile client terminal.

Now, a query which includes the one or more provided properties of the target wearable article is sent to the central unit 102 over the network 105, optionally with the estimated direction and/or distance. As shown at 207, this allows the system 100, for example the matching module 112, to try and match the one or more provided properties with properties of wearable articles of other users who are located in a certain distance from the user sending the query and optionally at the estimated direction and/or distance. The location of the users may be provided from the location monitoring module 113 which continuously or periodically monitor the location of users.

Optionally, if no match is found, the provided one or more properties of the wearable article are used to identify a similar wearable article from a wearable article database so as to allow advertising to the user wearable articles which are suitable to his taste based on the wearable article he liked.

Optionally, if more than one or more matching wearable articles are found, for example more than a certain predefined amount (i.e. more than 1-5 clothing articles), data indicative of properties of matching wearable articles of users identified in a certain distance from, for example in proximity to, the requesting user are sent to the mobile client terminal module 103. The certain distance may be defined by the user and/or set in advance. The certain distance understood as being located in an area around the user, for example within a certain radius from the user, for instance a radius of less than 5 meters (m), 10m, 15m, 20m, 25m, 50m, 100m and/or any intermediate or larger number. The certain distance may be detected by known distance calculation functions that receive as input locations of users monitored in 202-203. Optionally, the certain distance may be dynamically adjusted according the number of users which are located around the user. Optionally, wearable articles indicated as currently being worn by users are tagged and/or highly ranked so that it may be selected, matched and/or presented before other items. Optionally, information regarding queried wearable articles currently worn by a user is used by the system 100 to present other wearable articles of these users in a higher priority in a list shown to a querying user.

This allows generating a presentation facilitating the requesting user to select more properties that may allow the matching module 112 to match a single article from the wearable articles of users identified in proximity to the requesting user. The process depicted in 207 and 208 may be repeated until a match is found.

Optionally, if the amount of matching wearable articles is less than a certain predefined amount (i.e. less than 6) and/or if a single matching wearable article is found, wearable article information of the one or more matching wearable articles are sent to the user, for example as shown at 209. Now, as shown at 210, the matching wearable articles may be presented to the requesting user, allowing him to select one of the matching wearable articles. As shown at 211, upon selection, wearable article information about the selected matching wearable article may be presented.

In some embodiments of the present invention, the user client terminal hosting the user client terminal module may receive data about wearable articles of other users who are located in a certain distance from the user in response to a general query and/or continuously and/or periodically. In such embodiments, the user is not required to input any property(ies) of any target wearable article. The presented data may be segmented according to properties such as color and/or item type.

Optionally, as shown at 213, a matching wearable article rank is updated based on the query. In such an embodiment, wearable articles are ranked according to interest users expressed by querying thereabout. The wearable article rank is optionally associated with the respective user who wears it, allowing him to learn with which clothing his appearance attracts more attention. Optionally, a user rank is calculated by summing or otherwise using the wearable article ranks of his wearable articles. The user rank may be used as a value on a fashionability index to evaluate the fashionability of the user for example in relation to other users.

Optionally, if a number of queries are sent sequentially, one or more user profiles with matching wearable articles prioritized highly for retrieval.

According to some embodiments of the present invention, queries data, for example a query sending location, a query sending time, a query sending content (i.e. properties), a query sender identifier, and optionally wearable articles which have been matched thereto are logged. This allows aggregating data pertaining to a certain wearable article, for example in which time of the day it is been exposed to users who found it attractive, in which geographical locations it has been exposed to users who found it attractive, demographic characteristics of users who found it attractive of and/or which properties of the wearable article protrude above others. In another example, data extracted from matching wearable articles identified in response to queries submitted by a certain user are used for selecting advertisement for this certain user. In such an embodiment, the logged data may be sent to an ad module that can communicate with one or more ad servers for acquiring personalized advertisements. Optionally, data acquired in a certain location and optionally time is clustered to conclude which wearable article interests users who are currently located at the certain location and optionally at the certain time. This may be performed in real time and/or for future advertisement at the certain location and optionally at a respective time, for example the same time of the day. For example, if many users queried about red dresses in an area having a certain ad spot, such as a screen, an advertisement for a red dress may be presented on the screen. The data may be used for determining which static advertisements to post where and when.

These queries are considered as an indication of interest in a certain type style of wearable articles, an indication that may be used for personalized advertisement. For example, if the user submits, for example contiguously, a number of queries pertaining to red coats, a request for a suitable advertisement may be sent to an ad server and the respective ads received from the ad server may be presented to the requesting user, for example as banners, recommendations, personalized coupons, and/or the like.

Additionally or alternatively, data pertaining to preferences of users may forwarded to retailers and/or advertisers based on payments.

According to some embodiments of the present invention, the requesting user may perform one or more wearable article derivative actions. In such embodiments, each wearable article record may include data for facilitating respective wearable article derivative actions, for example link(s) to retailer website(s) which sell the wearable article record, link(s) to website(s) of one or more stores who sells the wearable article record, a wearable article rank, a location and/or contact details of one or more stores who sells the wearable article record, and/or the like. In such embodiments, the user client terminal module 103 may use the data from the wearable article record with respective functions and/or modules to allow the user to perform a wearable article derivative action, such as placing a purchase request, navigating to one of the respective stores, placing a call to one of the respective stores, sending an email or a fax to one of the respective stores, uploading a wearable article identifier to a wish list, posting a social network notice with the wearable article identifier and/or the like. In another example, the selecting user may use a UI of the user client terminal module 103 to rank the wearable article. This may be used to update the respective rank field in the wearable article record.

According to some embodiments of the present invention, the requesting user may perform one or more actions which are related to the user who owns the selected matching wearable article. In such embodiments, data from the user profile may be used for facilitating the user related actions. For example, wearable articles from the user profile are presented to the user. In another example, the requesting user may follow the user that is associated with the user profile. In such embodiments, the user may receive notifications about new purchases of the followed user and/or the like. In another example, the selecting user may use a UI of the user client terminal module 103 to rank the appearance of the user who wears the matching wearable article. The ranking may be used for calculating and/or updating a user rank, for example the above described user rank.

As described above, each one of the users of the system may have a user profile. Optionally, the user may manage privacy policy for the user profile, for example which wearable articles may be presented to other users, which other users may be presented with data from the user profile, and/or the like.

Optionally, the wearable articles in each user profile are managed as articles in a virtual closet, allowing the user to track and to monitor which wearable articles he owns. Optionally, the mobile client terminal module 103 includes an image processing module. The image processing module process images selected and/or captured by the user to extract one or more wearable article properties, such as color, collar type, type (e.g. a skirt, a dress, pants, shoes, a watch, glasses, and/or the like), size (e.g. S, M, L, XL, and/or the like), brand (e.g. Gucci™, Rolex™, H&M™, Prada and/or the like), and/or the like. In such a manner, the user profile may be updated according to images the user captures, selects and/or tags. Optionally, image wherein the user is tagged are analyzed using the image processing module to update the user profile, for example social media images, such as Facebook™ images.

Optionally, the mobile client terminal module 103 includes a barcode reading module, such as a QR module. In use, the user may scan barcodes associated with wearable articles he purchases and/or receives to update his user profile. The barcode may direct the mobile client terminal module 103 to a database including respective wearable article information.

According to some embodiments of the present invention, one mobile client terminal module 103 sends a query to one or more other mobile client terminal modules 103 located in proximity thereto. The message may be forwarded via the internet, for example via a proxy, such as a server that includes at least some of the functionalities of the central unit 102 and/or sent directly, via a WLAN connection, via a wireless personal area network (WPAN) connection, such as a Bluetooth™, near field communication (NFC), and/or ZigBee™ connection and/or any peer to peer connection. In response, optionally via the same communication channel, the queried mobile client(s) reply with the respective matching wearable article(s). When a direct connection is established, the matching module 112 may be implemented at the mobile client terminal modules 103 and a local database may be used to store properties of wearable articles and/or information about the physical appearance of the user, for instance a hairdresser data, plastic surgery data, and/or any of the aforementioned example re external appearance information. Optionally, in use, such a matching module may match between one or more wearable article properties which are provided in the query and one or more wearable article properties of each one of the wearable articles which are documented as related to a respective user. When a match is found, for example based on the wearable article information, a notification is presented to the querying user. Additionally or alternatively, the user which his client has been queried may be updated, for example using a GUI, for instance similarly to the described above. In such embodiments, a central unit, such as 102, may be used to gather additional data and/or updated with the queries for various reasons which are described above.

According to some embodiments of the present invention, the user profile may be updated to indicate the authenticity of one or more wearable articles. In such embodiments, the wearable article record may include a virtual authenticity certificate. The virtual authenticity certificate may be based on a unique identifier which may be loaded when a new wearable article is updated, for example by reading a barcode that is associated with the certain article. In such embodiments, the user may know if the selected wearable article is genuine article, such as a watch or a clothing article or a counterfeit. By updating the user profile with virtual authenticity certificates, the updating can demonstrate to other users that he wears genuine wearable articles. This may also deter users from wearing counterfeits are the system 100 will not indicate to other users that their wearable articles are genuine.

According to some embodiments of the present invention, the system may be used to compensate user for promoting, optionally positively, wearable articles they wear. In such embodiments, if a user purchases a wearable article like a wearable article he identified using the system, the user who owns the viewed wearable article receives game points and/or redeemable points. Additionally or alternatively, if a user highly ranks a wearable article like a wearable article he identified using the system, the user who owns the viewed wearable article receives game points and/or redeemable points.

According to some embodiments of the present invention, the system may be used for preventing from appearing in a certain area and/or a future event with the same wearable article as another user of the system. In such an embodiment, the user may update, for example using a GUI provided by the client terminal module 103, which wearable articles he is about to wear today. Optionally, in use, the matching module 112 may match between the wearable articles, which are currently worn by the user, and wearable articles, which are currently worn by other user(s) in his surroundings. It should be noted that in such embodiments, and in others, the user may indicate which articles he currently wears, for example using a GUI on his mobile client terminal. When a match is found, for example based on the wearable article information, a notification is presented to the user, allowing him to avoid being seen together with the user(s) who wear the same wearable article. Additionally or alternatively, the user may update, for example using the GUI, which wearable articles he is about to wear to a certain future event. The event may be identified by location (i.e. address and/or coordinates) and time. In use, the matching module 112 may match the wearable articles which the user is about to wear to the event with wearable articles which are either currently worn by user(s) in the event or wearable articles which are marked as about to be worn to the event by one or more other users. Optionally, the system alerts users when another user which arrives at an event is about to wear the same wearable articles. Optionally, the system manages a reservation database wherein user may reserve the opportunity to wear certain wearable article(s) to certain event(s). Optionally, the system acquires event participation data from a third party, for example from one or more social networks. If the event participation data indicates that a number of users who owns the same wearable article intend to participate in the same event, an alert message is sent to these users, indicating which wearable articles may be worn by other users.

According to some embodiments of the present invention, the system includes a billing module which bills clients, for example fashion companies and/or stores, based on the number of queries filed re their wearable article, the number times a response to a query filed re their wearable article has been provided to users, and/or the number times a link to their website (or a related website) is provided in response to a query filed re their wearable article has been provided to users.

According to some embodiments of the present invention, the system 100 allows the user, which may be subscriber to locate other users which are proximate to them or if no other user is proximate. This may be done using the location monitoring module 113 that monitors the location of users. Optionally, the system 100 allows user to locate users who wear a certain wearable article, for example providing navigation instructions and/or alerts when the wearing user is in a certain distance therefrom. Optionally, the system 100 allows user to locate proximate users who wear a highly ranked article and/or being ranked with a fashionability rank. Optionally, the system 100 dynamically maps areas according to the number of queries sent in them. The higher the number of queries in a certain area, the highest is the rank of the area. Optionally, alerts about highly ranked areas are sent to users. Optionally, alerts about highly ranked wearable article which is located in proximity thereto are sent to users.

According to some embodiments of the present invention, the system 100 includes an ecommerce module that allows a user to tag some or all of their wearable articles for sale and another user to send a message indicating his interest in purchasing one or more of the wearable articles to this user.

The methods as described above are used in the fabrication of integrated circuit chips.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a server, a module, a network is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A method of identifying a wearable article, comprising:
managing a plurality of user profiles each indicative of at least one descriptive property of each of a plurality of wearable articles associated with one of a plurality of users;
monitoring a location of a plurality of mobile client terminals each associated with another of said plurality of users;
receiving from a first of said plurality of mobile client terminals a user inputted query comprising indication of at least one wearable article property of a proximate wearable article;
selecting a group of said plurality of user profiles according to a distance between a current location of said first mobile client terminal and a current location of at least one second mobile device from said plurality of mobile client terminals;
identifying which member of said group has a matching wearable article with at least one descriptive property which matches to said at least one wearable article property;
extracting wearable article information of said matching wearable article; and
forwarding said wearable article information to for presentation on a display of said first mobile client terminal as a response to said user inputted query;
wherein said at least one descriptive property comprises a member of a group consisting of a color, a collar type, a type, a gender designation, a fabric and a size.

2. The method of claim 1, wherein said managing comprises associating each one of said plurality of wearable articles with respective wearable article information.

3. The method of claim 1, wherein said managing comprises associating between a user of said plurality of users and a new wearable article in response to a transaction made by said user to purchase said new wearable article.

4. The method of claim 1, wherein said receiving comprises receiving an estimation of at least one of a distance and a direction of said proximate wearable article, said selecting is performed according to said at least one of said distance and said direction.

5. The method of claim 1, wherein said wearable article information comprises a member of a group consisting of a unique identifier (ID), an origin retailer, a name, a manufacturer, a current price, a paid price, and a stock availability.

6. The method of claim 1, wherein said wearable article information comprises a virtual authenticity certificate which indicates the authenticity of said matching wearable article.

7. The method of claim 1, wherein said wearable article is a clothing item worn by another of said plurality of users.

8. (canceled)

9. The method of claim 1, wherein said identifying comprises:
identifying a plurality of members of said group each having a matching wearable article with said at least one descriptive property,
extracting at a plurality of distinguishing descriptive properties from said plurality of members,
sending said plurality of distinguishing descriptive properties to said mobile client terminal, and
identifying which of said plurality of members said matching wearable article according to a match with a group of said plurality of distinguishing descriptive properties which is selected by said user.

10. The method of claim 1, further comprising receiving from a each of a first and a second of said plurality of users data indicative of which of respective said plurality of wearable articles they wear to an event held in a certain place and time, identifying a match between wearable articles indicated by said first and second users for said event, and alerting at least one of said first and second users about said match.

11. A method of identifying a wearable article, comprising:
forwarding a current location of a mobile client terminal of a user to a central unit via a communication network;
inputting by said user a query comprising an indication of at least one wearable article property of a target wearable article worn by another user located in proximity to said current location;
sending said at least one wearable article property to said central unit via said communication network;
receiving a message comprising wearable article information of said target wearable article in response to said at least one wearable article property; and
presenting at least one of said wearable article information and data acquired based on said wearable article information to said user using said mobile client terminal;
wherein said at least one wearable article property comprises a member of a group consisting of a color, a collar type, a type, a gender designation, a fabric and a size.

12. The method of claim 11, wherein said receiving comprises capturing an image of said target wearable article according to a user indication and automatically extracting said at least one wearable article property by an image analysis of said image.

13. The method of claim 11, further comprising receiving a rank given for said target wearable article from said user and updating accordingly at least one of said another user and the attractiveness of said another user with said target wearable.

14. The method of claim 11, further comprising crediting an account of said another user according to said presenting.

15. The method of claim 11, further comprising uploading a note with said wearable article information to at least one of a social media page and wish list.

16. The method of claim 11, further comprising directing a browser hosted on said mobile client terminal to a webpage of a retailer selling said wearable article target wearable article.

17. The method of claim 11, further comprising operating a navigation module installed in said mobile client terminal to generate navigation instructions to a store associated with said wearable article target wearable article.

18. The method of claim 11, further comprising operating a call module installed in said mobile client terminal to generate call instructions to establish a call with a retailer associated with said wearable article target wearable article.

19-20. (canceled)

21. A system of identifying a wearable article, comprising:
a database which stores a plurality of user profiles each indicative of at least one descriptive property of each of a plurality of wearable articles associated with one of a plurality of users;
a plurality of client modules installed in a plurality of mobile client terminals each said client module monitors a current location of a respective said mobile client terminal, renders a user interface allowing a user to indicate at least one wearable article property of a proximate wearable article located in proximity said current location, and sends a query comprising said at least one wearable article property over a network; and
a central unit which receives said query and selects according to data from said database a matching wearable article having said at least one wearable article property;
wherein said central unit forwards wearable article information of said matching wearable article to a first of said plurality of mobile client terminals which sends said query and said first mobile client terminal presents said indicative data to said user in response to said query;
wherein said at least one descriptive property comprises a member of a group consisting of a color, a collar type, a type, a gender designation, a fabric and a size.

22. The system of claim 21, wherein said plurality of client modules are used for capturing a plurality of images of a plurality of barcodes each indicative of said wearable article information of another of said plurality of wearable articles and to update said plurality of user profiles accordingly.

23-25. (canceled)

26. The system of claim 21, wherein
said central unit having a logging module which logs a plurality of queries from said plurality of client modules about a plurality of wearable articles worn by said plurality of users; wherein said plurality of queries are analyzed to deduce an attractiveness of each of said plurality of wearable articles.

27. (canceled)
